(19) United States
(12) Patent Application Publication
(10) Pub. No.: US 2002/0054015 A1
(43) Pub. Date: May 9, 2002

(54) Control device

(75) Inventors: Gary Wingett, Southampton (GB); Philip Barrowclough, Basingstoke (GB)

Correspondence Address: WARE, FRESSOLA, VAN DER SLUYS & ADOLPHSON LLP, 755 Main Street, P.O. Box 224, Monroe, CT, 06468, US

(73) Assignee: Nokia Mobile Phones Ltd.

(21) Appl. No.: 09/929,820

(22) Filed: Aug. 14, 2001

(30) Foreign Application Priority Data
Sep. 25, 2000 (GB) 0023475.7

(51) Int. Cl. G09G 5/08

(52) U.S. Cl. 345/156

(57) ABSTRACT

A control device (1) comprises a control member (4) for manipulation by a user, a strain sensor (5) to detect force applied to the control member by the user and resilient member (7) to permit movement of the control member and provide feedback to the user.

### FIELD OF THE INVENTION

The present invention relates to a control device.

### BACKGROUND ART

A pointing device, such as a touch sensitive pad, mouse, joystick, miniature joystick or trackball may be used to control many types of electronic apparatus. For example, the pointing device may be used to move an object, such as a cursor, displayed on a monitor or screen of a personal computer, television, mobile telephone, personal digital assistant (PDA), game console, hand-held electronic game and digital video disc (DVD) player.

A stick-type of pointing device, also known as a micro- or miniature joystick, is well known in the field of lap top computers for controlling movement of a pointer around a display. The pointing device comprises a control stick upstanding from a substrate and a plurality of strain-sensitive resistors.

The user places their finger on the control stick and applies lateral force to it. This induces strain in the control stick and substrate, which is detected by the strain-sensitive resistors. Changes in impedance of the resistors are detected using resistance bridges, which generate analogue electrical signals. These analogue signals are digitised, processed and converted into corresponding movements of the pointer.

EP-A-0681261 and EP-A-0844584 disclose stick-type pointing devices having strain-sensitive resistors mounted to the sides of the control stick. U.S. Pat. No. 5,640,178 and U.S. Pat. No. 5,659,334 disclose stick-type pointing devices having strain-sensitive resistors mounted to the substrate.

The stick-type pointing device may also be configured to detect a downward applied force, when the user presses down on the control stick. This is used to control selection of objects, such as icons, similar to selection using a mouse button.

Usually, the pointing device is configured so that the resistors are sensitive to the amount of force applied. This may be used to control the speed of movement of the pointer. Thus, the greater the applied force, the quicker the pointer will move. This is especially useful for computer game applications. However, the user may find the response of the pointing device over-sensitive and unrealistic, thus making control of the movement of the pointer difficult. In particular, the rigid control stick provides no feedback when the user pushes it.

The present invention seeks to provide an improved pointing device.

### SUMMARY OF THE INVENTION

According to the present invention there is provided a control device for converting applied force into electrical signals for electronic apparatus, the device comprising a control member for manipulation by a user, a strain sensor to detect force applied to the control member by the user and a resilient member to permit movement of the control member and provide feedback to the user.

The control member and strain sensor may be arranged as a moveable pointing device which is supported by the resilient member, the resilient member being configured to resist movement of the pointing device. A rigid plate may be disposed between the pointing device and the resilient member.

The device may include a support substrate, the resilient member being mounted on the support substrate and the pointing device being mounted on the resilient member.

The resilient member may be arranged so as to transmit force from the control member to the strain sensor. The resilient member may be disposed between the control member and the strain sensor or the resilient member and the control member may be configured as a unitary member.

The resilient member may be compressible or stretchable, cylindrical, toroidal, helical or comprise a supportive cup. The resilient member may be made of rubber, metal or plastic.

The strain sensor may comprise a resistive element.

According to the present invention there is also provided electronic apparatus including the control device. The apparatus may include a display device, the control device being configured to control operation of the display device. The apparatus may be portable, such as a mobile telephone handset or computer.

According to the present invention there is provided a method of fabricating a control device for converting applied force into electrical signals for electronic apparatus, the method comprising providing a control member for manipulation by a user, providing a strain sensor to detect force applied to the control member and providing resilient member to permit movement of the control member and provide feedback to the user.

### BRIEF DESCRIPTION OF THE DRAWINGS

Embodiments of the present invention will now be described, by way of example, with reference to the accompanying drawings, in which:

FIG. 1a is a perspective view of a first embodiment of the present invention;

FIG. 1b a perspective view of the embodiment shown in FIG. 1a with a protective cover lifted;

FIG. 2a is an exploded side view of the embodiment shown in FIGS. 1a and 1b;

FIG. 2b is an exploded perspective view of the embodiment shown in FIGS. 1a and 1b;

FIG. 3a is a side view of the embodiment shown in FIG. 1a without lateral force applied;

FIG. 3b is a side view of the embodiment shown in FIG. 1a with lateral force applied;

FIG. 4a is an exploded view a second embodiment of the present invention as seen from below;

FIG. 4b is a exploded view of the embodiment shown in FIG. 4a as seen from above;

FIG. 5a is a side view of the embodiment shown in FIG. 4a without force applied;

FIG. 5b is a side view of the embodiment shown in FIG. 4a with force applied;

FIG. 6 is an exploded view of a third embodiment of the present invention;

FIG. 7 is an exploded view of a fourth embodiment of the present invention; and

FIG. 8 is a block diagram illustration of an electronic apparatus including a control device, such as shown in the first through fourth embodiments of the present invention.

### PREFERRED EMBODIMENTS OF THE INVENTION

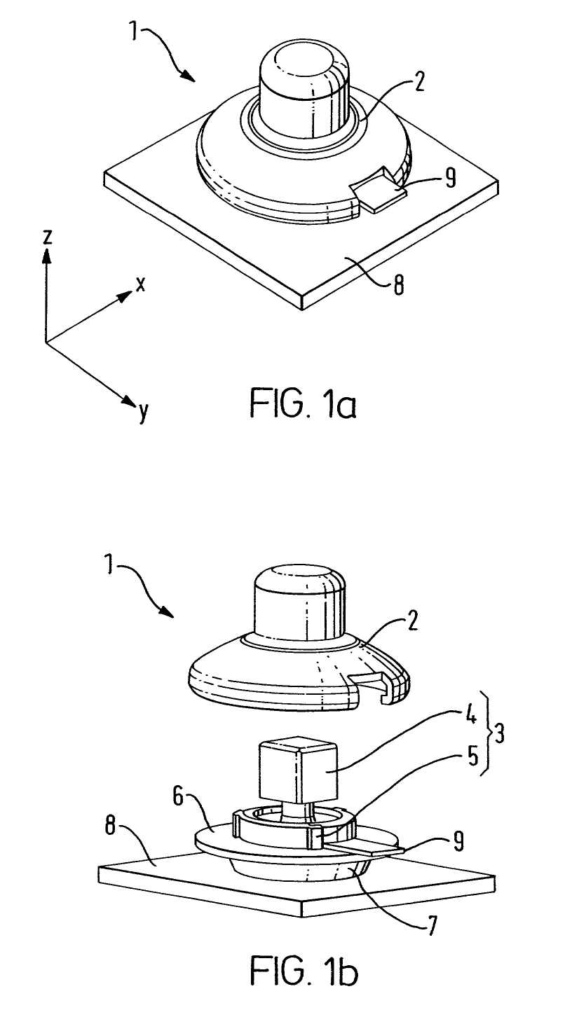

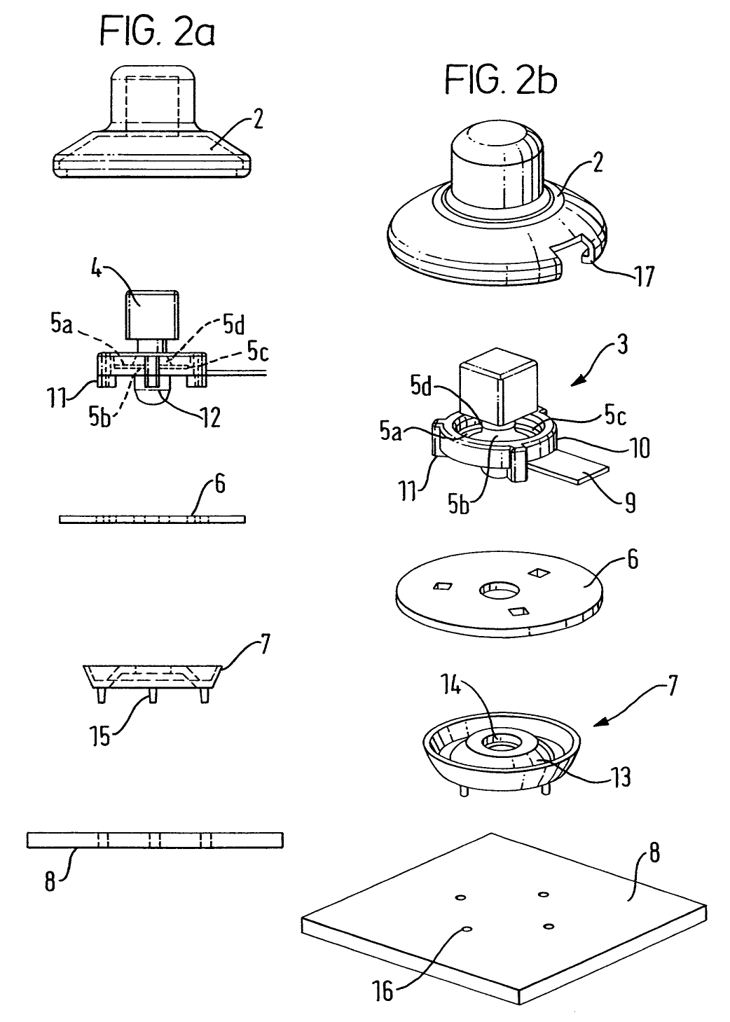

Referring to FIGS. 1a and 1b, a first embodiment of a strain gauge pointing device 1 is shown with and without a protective cover 2 in place. The pointing device 1 comprises a stick-type pointing device 3 comprising a control member 4 upstanding from a transducer structure 5 fitted to a rigid plate 6 that is mounted on a rubber base 7. Strain-sensitive resistors 5a, 5b, 5c, 5d are disposed within the body of the transducer structure 5 in a well-known manner. In this example, the rubber base 7 is located on a support substrate, in this example a printed circuit board (PCB) 8, which forms part of the electronic apparatus (not shown). The pointing device 3 is electrically connected to the electronic apparatus though a flexible ribbon cable 9. Assembly of the resilient pointing device 1 is shown in more detail in FIGS. 2a and 2b.

Referring to FIGS. 2a and 2b, the stick-type pointing device 3 is of a type well known in the art and is generally circular in plan view. The pointing device 3 comprises an annular rim 10 having three equidistant legs 11 extending first radially, then downwardly, towards the PCB 8. The pointing device 3 further comprises a lobe 12 which rests on the PCB 8 and serves as a point about which the pointing device 3 may pivot. The legs 11 press-fit into slots 12 formed in the rigid plate 6. The rigid plate 6 is disc-shaped and is formed from durable plastic, although it will be appreciated that the rigid plate 6 may also be formed from thin gauge steel or magnesium.

The rigid plate 6 is bonded on top of the rubber base 7. In this example, the base 7 is generally bowl-shaped with a mesa 13 in the centre. The mesa 13 has a hole 14 in the middle to receive the lobe 12. The base 7 has four posts 15, which are glued into slots 16 in the PCB 8. It will be appreciated that the rubber base 7 may be formed from other resilient materials and may have other shapes. For example, the base 7 may be a rubber ‘O’-ring, a keymat or a rubber disc.

It will be appreciated that other methods of attaching the pointing device 3 to the rigid plate 6 and the rigid plate 6 to the rubber base 7 may be used. For example, the pointing device 3 and the rigid plate 6 may be a unitary structure. The rigid plate 6 and the rubber base may be glued or thermally bonded together.

Finally, the rubber protective cover 2 is placed over the positioning device 3 and secured by means of a lip 17 over the edge of the rigid plate 6.

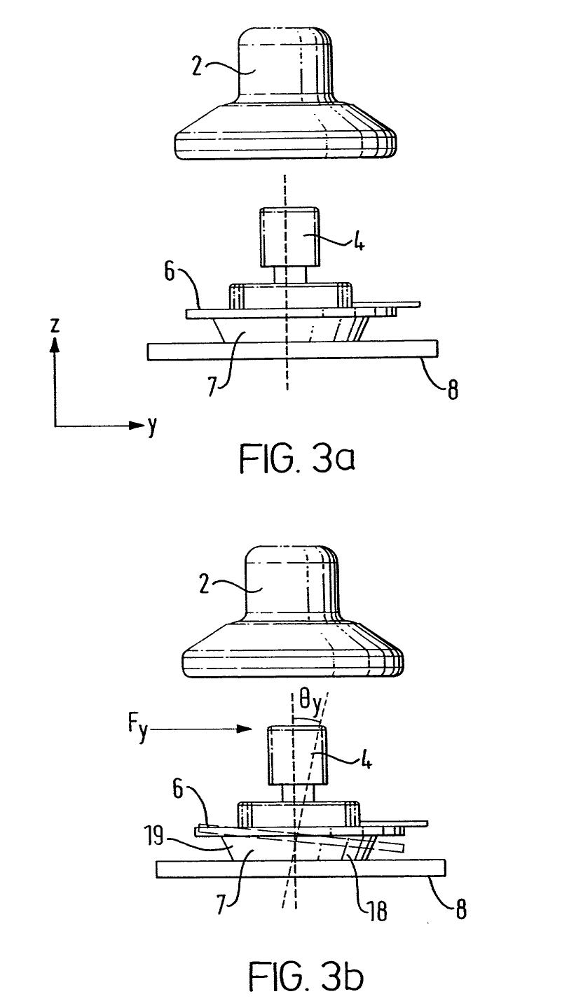

The configuration shown in FIGS. 1 and 2 allows the pointing device 3 to move relative to the PCB 8. This is explained in more detail with reference to FIGS. 3a and 3b.

Referring to FIGS. 1a, 3a and 3b, a resilient pointing device 1 is shown with the protective cover 2 removed. If no lateral force is applied to the free end of the control member 4, the pointing device 3 sits with the control member 4 substantially upright, as shown in FIG. 3a. If a lateral force F_{y} is applied to the free end of the control member 4 in the direction of the y-axis by the user's finger, the pointing device 3 and the rigid plate 6 are tilted towards the y-axis, by an angle θ_{y} from the z-axis. The rubber base 7 is deformed, with a leading side 18 being downwardly compressed between the rigid plate 6 and the PCB 8 and a trailing side 19 being upwardly stretched by the rigid plate 6 from the PCB 8, as shown in FIG. 3b. The base 7 resists this deformation and so the user feels resistance against their finger. As the user applies greater lateral force F_{y} by pressing harder, the angle of tilt θ_{y} is increased, deformation is increased and so resistance to the applied force F_{y} is also increased. Therefore, the user will experience positive feedback. If the user applies a very large lateral force F_{y}, the pointing device 3 and the rigid plate 6 are tilted sufficiently that the leading edge of the rigid plate 6 presses against the PCB 8, thus preventing further tilting.

Similarly, if a lateral force Fₓ is applied parallel to the free end of the control member 4 in the direction of the x-axis, the pointing device 3 is tilted towards the x-axis.

Thus, the pointing device 3 may be tilted from z-axis in any direction in the x-y plane. Thus, the user is able to navigate the resilient pointing device 1 through 360° in the x-y plane and move an object, such as a cursor, around a display.

This configuration has the advantage that, as a larger force is applied to the pointing device 3 and the cursor accelerates, the user feels greater resistance from the pointing device 3. This response from the pointing stick 3 feels more intuitive and the user finds it easier to control the movement of the cursor. It will be appreciated that characteristics of the rubber base 7, such as its elasticity, may be tailored to the electronic apparatus and its intended application.

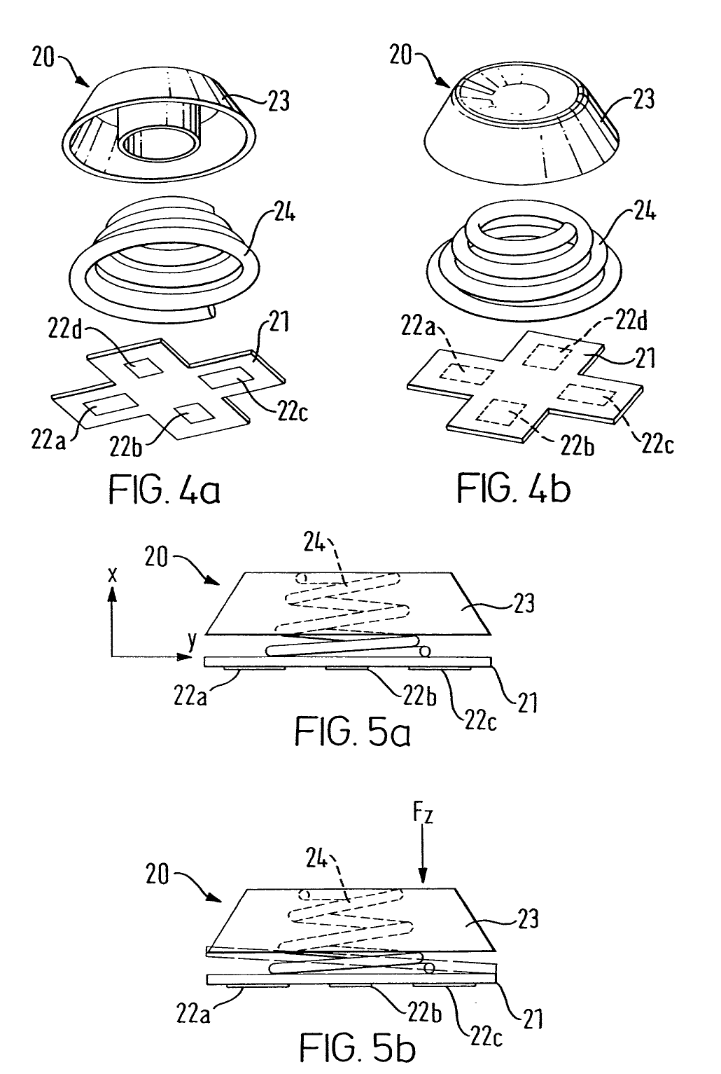

Referring to FIGS. 4a and 4b, a second embodiment of a pointing device 20 is shown. The second pointing device 20 comprises a strain gauge element 21 to the underside of which are mounted strain-sensitive resistors 22a, 22b, 22c, 22d In this example, the strain gauge element 21 is a ceramic cruciform of a type well known in the art. The pointing device 20 further comprises an actuator 23 to which a user can apply a force using a finger or thumb. In this example, the actuator 23 is a button made of durable plastic, although other materials may be used. A force applied to the actuator 23 is transmitted to the strain gauge element 21 via a resilient member 24, such as a coil spring. The coil string may be made from metal or plastic. The resilient member 24 is bonded to the strain gauge element 21. It will be appreciated that if the coil spring is used, it may be mounted to the strain gauge element 21 at one end of the spring or along at least part of coil. The resilient member 24 may be bonded, glued or clipped to the strain gauge element 21. Similarly, the coil spring may be bonded, glued, moulded into or clipped to the actuator 23 at its other end. The strain-gauge element 21 may for part of or be mounted to a substrate, such as a PCB.

When assembled, the arrangement shown in FIGS. 4a and 4b allows the user to apply lateral and vertical forces to the actuator 23 using their finger or thumb and to feel the actuator 23 move. This is explained in more detail with reference to FIGS. 5a and 5b.

If no force is applied to the actuator 23, it sits substantially level, as shown in FIG. 5a. If an off-centre downward force F_{z} is applied substantially along the y-axis by the user's finger, the actuator 23 tilts towards the y-axis, as shown in FIG. 5b. The spring 24 is bent and resists movement. The user feels the actuator 23 move and resistance against their finger. The spring 24 induces strain in the strain-gauge element 21, which is measured by the strain-sensitive resistors 22a, 22b, 22c, 22d in a well-known manner. If the user applies a greater force by pressing harder, the actuator 23 moves even more. The amount of movement and the degree of resistance felt by the user may be adjusted using springs with different spring rates.

The second pointing device 20 may be tilted in any direction in the x-y plane, which may be used to navigate an object, such as a cursor around a display.

The arrangement shown in FIGS. 4a and 4b may also be used to detect application of an on-centre downward force. If the user applies an on-centre downward force, the spring 24 may be compressed and this downward movement may be felt by the user. The strain-gauge element 21 may be configured to detect this centrally applied force. This may be used for example to select objects using the navigable object. Alternatively, a separate switch (not shown) may be used to detect downward movement.

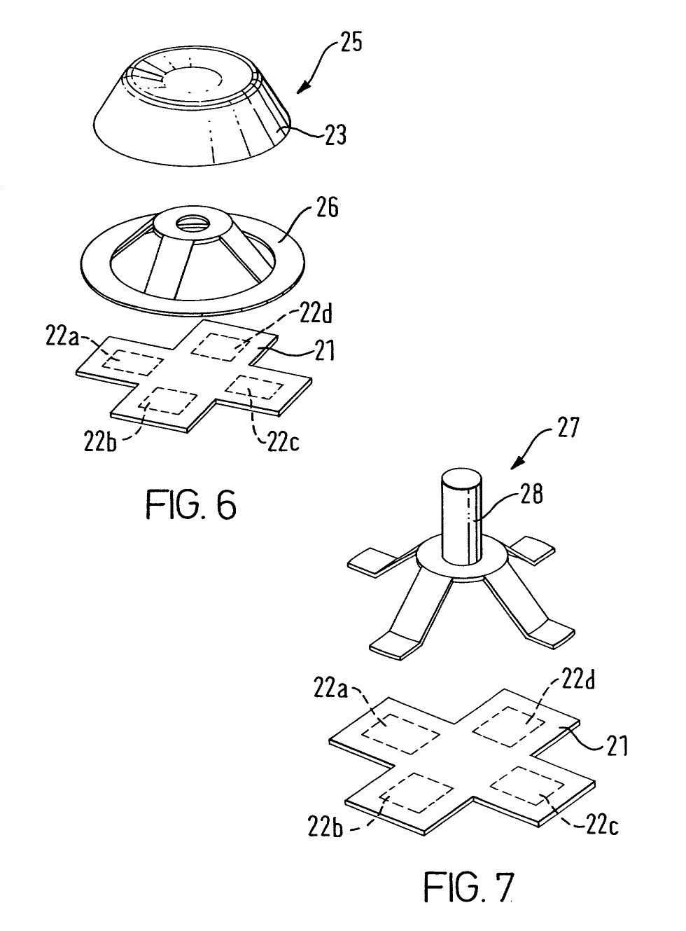

Referring to FIG. 6, a third embodiment of a pointing device 25 is shown. The third pointing device 25 is similar to the second device 20 except that a resilient frame 26 is used instead of a coil spring. The frame 26 may be made from metal, plastic or rubber.

Referring to FIG. 7, a fourth embodiment of a resilient pointing device 27 is shown. In the fourth pointing device 27, the actuator and the resilient member form a unitary structure 28.

It will be appreciated that the invention can be used in relation to any sort of electronic apparatus, both portable and non-portable. This may include mobile telephone handsets and lap top computers.

Referring to FIG. 8, an electronic apparatus 30 includes a control device 32, such as shown in connection with the first through fourth embodiments of the invention. The apparatus 30 may include a display device 34 with the control device 32 being configured to control operation of the display device through a display control 36. The apparatus 30 may be portable, such as a mobile telephone handset. The apparatus 30 may be a stationary or desktop type computer or a portable computer, such as a laptop. In the case of a laptop, the control device 32 would naturally be incorporated in the body of the apparatus 30 or may be connected through a port, such as a USB port. In the case of a desktop electronic apparatus, the control device may be connected by a USB port or some other port, such as a port normally used for a joystick.

It will be appreciated that many modifications may be made. For example, the base and rigid plate need not be circular in plan view, but may be polygonal, especially regularly polygonal.

1. A control device for converting applied force into electrical signals for electronic apparatus, the device comprising a control member for manipulation by a user, a strain sensor to detect force applied to the control member by the user and a resilient member to permit movement of the control member and provide feedback to the user.

2. A control device according to claim 1, wherein the control member and strain sensor are arranged as a moveable pointing device which is supported by the resilient member, the resilient member being configured to resist movement of the pointing device.

3. A device according to claim 2, wherein a rigid plate is disposed between the pointing device and the resilient member.

4. A device according to claim 2, further including a support substrate, the resilient member being mounted on the support substrate and the pointing device being mounted on the resilient member.

5. A device according to claim 1, wherein the resilient member is arranged so as to transmit force from the control member to the strain sensor.

6. A device according to claim 5, wherein the resilient member is disposed between the control member and the strain sensor.

7. A device according to claim 5, wherein the resilient member and the control member are configured as a unitary member.

8. A device according to claim 1, wherein the resilient member is compressible.

9. A device according to claim 1, wherein the resilient member is stretchable.

10. A device according to claim 1, wherein the resilient member is cylindrical.

11. A device according to claim 1, wherein the resilient member is toroidal.

12. A device according to claim 1, wherein the resilient member is a helical.

13. A device according to claim 1, wherein the resilient member comprises a supportive cup.

14. A device according to claim 1, wherein the resilient member is made of rubber.

15. A device according to claim 1, wherein the resilient member is made of metal.

16. A device according to claim 1, wherein the resilient member is made of plastic.

17. A device according to claim 1, wherein the strain sensor comprises a resistive element.

18. Electronic apparatus including a control device according to claim 1.

19. Apparatus according to claim 18 including a display device, the control device being configured to control operation of the display device.

20. Apparatus according to claim 18, which is portable.

21. Apparatus according to claim 20, wherein said electronic apparatus is a mobile telephone handset.

22. Apparatus according to claim 20, wherein said electronic apparatus is a computer.

23. A method of fabricating a control device for converting applied force into electrical signals for electronic apparatus, the method comprising providing a control member for manipulation by a user, providing a strain sensor to detect force applied to the control member and providing resilient member to permit movement of the control member and provide feedback to the user.
